(19) United States
(12) Patent Application Publication
(10) Pub. No.: US 2017/0283270 A1
(43) Pub. Date: Oct. 5, 2017

(54) NOVEL GRAPHENE-LIKE Si2BN MATERIAL AND METHOD OF MAKING THEREOF

(71) Applicant: University of Kentucky Research Foundation, Lexington, KY (US)

(72) Inventor: Madhu Menon, Lexington, KY (US)

(21) Appl. No.: 15/473,794

(22) Filed: Mar. 30, 2017

Related U.S. Application Data
(60) Provisional application No. 62/315,162, filed on Mar. 30, 2016.

(51) Int. Cl. C01B 35/14

(52) U.S. Cl. CPC C01B 35/14; C01P 2004/20; B82Y 40/00

(57) ABSTRACT

This application relates to monolayers of Si₂BN or C₂BN, arranged in a graphiticized hexagonal arrangement. Each Si/C atom has a Si/C, B, and N nearest neighbor, while each B (N) has two Si/C's and one N (B) as nearest neighbors. The monolayer can be a 2D composition or can be “rolled” into a nanotubular 3D arm-chair or zig-zag configuration.

### RELATED APPLICATIONS

This application claims priority to U.S. Provisional Patent Application 62/315,162, filed Mar. 30, 2016, which is hereby incorporated by reference it its entirety.

### TECHNICAL FIELD

This document relates to a new stable graphene-like single atomic layered Si₂BN structure that has all of its atoms with sp² bonding with no out of plane buckling. The structure is found to be metallic with a finite density of states at the Fermi level. The unique composition and electronic properties show potential for new applications beyond graphene.

### BACKGROUND SECTION

While the possibility to create a single-atom thick 2D layer from any material remains desirable, only a few such structures have been obtained other than graphene and monolayer of boron nitride. Monolayers of Si, called silicene, have been synthesized but are found to be puckered rather than a preferred flat 2D sheet and are also intrinsically unstable against the formation of an sp³-like hybridized, bulk-like silicon structure, thereby negating their 2D potential. Conversely, herein, based upon ab initio theoretical simulations, a new stable graphene-like single atomic layered Si₂BN structure is identified that has all of its atoms with sp² bonding with no out of plane buckling. The structure is metallic with a finite density of states at the Fermi level. The structure can be rolled into nanotubes in a manner similar to graphene. The unique composition and electronic properties show potential for new applications beyond graphene.

### SUMMARY OF THE INVENTION

Herein is described a graphiticized hexagonal monolayer of Si₂BN, wherein each Si atom has a Si, B, and N nearest neighbor, each B has two Si's and one N as nearest neighbors and each N has two Si's and one B as nearest neighbors. In some embodiments, the monolayer of claim 1, wherein the Si2BN comprises the structure:

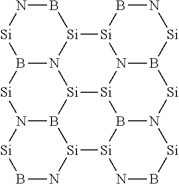

Within the monolayer, each atom is connected by sp² bonding, allowing the resulting to rest within a single plane that does not buckle out.

In certain embodiments, the monolayer is rolled to achieve a zig-zag orientation nanotube. In other embodiments, the monolayer is rolled to achieve an arm-chair orientation nanotube.

In further embodiments, the graphiticized hexagonal monolayer may comprise X₂BN with a structure of:

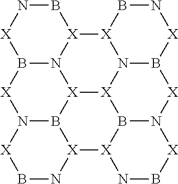

wherein X is carbon or silicon.

Also herein is described methods for manufacturing the monolayers, comprising reacting ammonium borate and silane on a copper substrate under high vacuum.

### BRIEF DESCRIPTION OF THE DRAWINGS

FIG. 1 shows the HSE06 optimized Si₂BN structure (top panel) and the pair correlation function of four nearest neighbor bond lengths (bottom panel). The differences in Si—Si, Si—B, Si—N and B—N bond lengths result in considerable amount of structural stress and the lack of in-plane isotropy under 120° rotations found in graphitic C and BN. The pair correlation function shown in FIG. 1 (bottom panel) illustrates the four distinct nearest neighbor bond lengths in the lattice.

FIG. 2 shows phonon dispersion relation (left) and total phonon density of states (right) for the Si2BN structure obtained using the HSE06 hybrid functional. Absence of any negative frequencies indicate structural stability.

FIGS. 3a and 3b show two additional structural models considered for the Si2BN layer. The DFT simulations for these resulted in out of plane buckling and distortions.

FIG. 4 shows calculated band structure (left) and density of states (right) obtained with the HSE06 hybrid functional for the Si2BN monolayer. The Fermi energy is indicated by the dashed lines.

### DETAILED DESCRIPTION

The present invention provides for a new stable graphene-like single atomic layered hexagonal Si₂BN structure or a variant C₂BN structure. The resulting obtained structure has all of its atoms with sp² bonding with no out of plane buckling. This structure is metallic with a finite density of states at the Fermi level. Further, this structure can be rolled into nanotubes in a manner similar to graphene. The unique composition and electronic properties thus show potential for new applications beyond graphene.

The following structure depicts an embodiment for the arrangement of the Si, B and N atoms within a hexangonal monolayer:

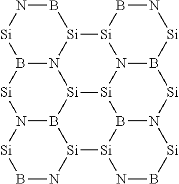

To summarize, the structure can be viewed as repeats of two rows of connected hexagons, with silicon atoms placed and the 1 and 4 positions within each and boron and nitride alternatively at the 2,5 and 3, 6 positions, switching accordingly in an adjacent structure, as according to the following structure:

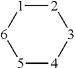

The two rows are connected by silicon dimers atoms, thereby completing the hexagonal matrix. Each Si atom has a Si, B, and N nearest neighbor, while each B (N) has two Si's and one N (B) as nearest neighbors. In some alternative embodiments, carbon can be utilized instead of silicon to provide a C₂BN hexagonally arranged monolayer.

In some embodiments, the monolayer is of the formula X2BN, wherein X is carbon or silicon. Each X atom has a X, B, and N nearest neighbor, while each B (N) has two X's and one N (B) as nearest neighbors. An exemplary structure is as follows:

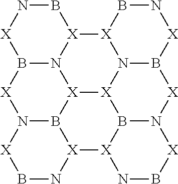

Because of the surge of interest in 2-D materials, fueled by the discovery of graphene, the possibility of growing novel single layered forms of stable sp² bonded phases of materials other than carbon has attracted much scientific interest (Novoselov et al., Science 306, 666 (2004)). The unique qualities of 2D materials, such as their reduced dimensionality and symmetry, lead to the appearance of phenomena that are very different from those of their bulk material counterparts. 2-D materials offer opportunities for new fundamental studies to address single-layer scale differences in interfacial electron-electron and electron-phonon couplings; excitonic and other quasiparticle properties; the effects of defects and the substrate; the influence of doping, strain effects, and electric fields; mechanical properties; quantum size effects; and edge effects in transport (Butler et al., ACS Nano 7, 2898 (2013), pMID: 23464873, http://dx.doi.org/10.1021/nn400280c, URL: dx.doi.org/10.1021/nn400280c).

Graphene-structure can also be formed by combining boron and nitrogen, which like carbon, belong to the first row of the Periodic Table. The resulting all sp² bonded single layered hexagonal boron nitride (BN) structure is a wide band gap semiconductor with a gap of 5.8 eV (Rubio et al., Phys. Rev. B 49, 5081 (1994)). Furthermore, stoichiometric combinations of C, B, and N has also been used to create graphitic hybrids of graphite and BN (Liu et al., Phys. Rev. B 39, 1760 (1989)). More recently, a silicon analogue to graphene called silicine has been the subject of investigations (Aufray et al., Appl. Phys. Lett. 96, 183102 (2010)). Similarly, a germanium monolayer has also been synthesized (Bianco et al., ACS Nano p. DOI: 10.1021/nn4009406 (2013)). However, these layers were found to be organized into a puckered hexagonal lattice configuration rather than a flat monolayer (Vogt et al., Phys. Rev. Lett. 108, 155501 (2012)).

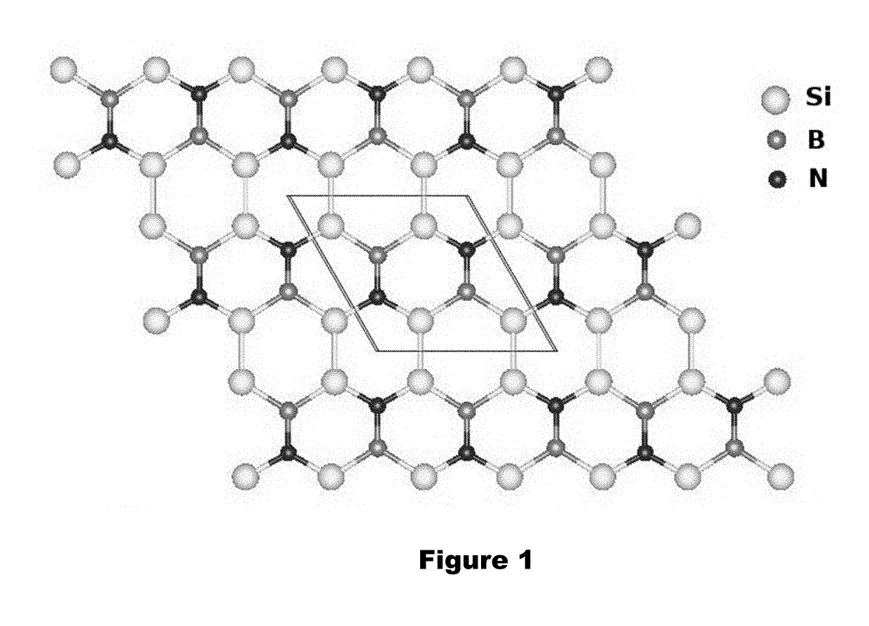

Herein is described a new class of hexagonal graphene-like lattice with sp² bonding configuration consisting of Si, B, and N, or alternatively C, B and N. The structure comprises Si—Si—B—N arranged in graphitic layer in which each Si atom has a Si, B, and N nearest neighbor, while each B (N) has two Si's and one N (B) as nearest neighbors (see, FIG. 1, top panel). In other embodiments with carbon, the structure comprises C—C—B—N arranged in graphitic layer in which each C atom has a C, B, and N nearest neighbor, while each B (N) has two C's and one N (B) as nearest neighbors. These arrangements clearly avoid the formation of energetically unfavorable B—B and N—N bonds, while optimizing the number of Si—Si (or C—C) and B—N bonds. The unit cell (inset to FIG. 1, top panel) contains 8 atoms and the structure has inversion symmetry.

Using ab initio density functional theory (DFT) simulations, the hybrid exchange-correlation functional, Heyd-Scuseria-Ernzerhof (HSE06) (Heyd et al., J. Chem. Phys 124, 219906 (2006)) was used, which features exact exchange and, therefore, provides results for the electronic structure in better agreement with experiment. All obtained ab initio calculations were performed using the Vienna Ab Initio Simulation Package (VASP) electronic structure computer code (Kresse et al., Phys. Rev. B 54, 11169 (1996)). The optimization of atomic positions (including full cell optimization) was allowed to proceed without any symmetry constraints until the force on each atom is less than 5 meV/Å.

In the fully optimized structure shown in FIG. 1, the differences in the Si—Si, Si—B, Si—N and B—N bond lengths results in considerable amount of structural stress and the lack of in-plane isotropy under 120° rotations found in graphene-like C and BN. The pair correlation function shown in FIG. 1 (bottom) illustrates the four distinct nearest neighbor bond lengths in the lattice.

The stability of the structure was tested using ab initio molecular dynamics (MD) simulations at high temperatures by applying the standard DFT theory (See Perdew et al. Phys. Rev. Lett. 77 3865 (1996)). All simulations were carried out using the Born-Oppenheimer molecular dynamics making use of the NPT ensembles of the VASP code, employing a computational cell containing 160 atoms subject to standard periodic boundary conditions and an integration time step of 1.5 fs. The energies and forces are obtained from electronic structure calculations within the generalized gradient approximation (GGA) of the DFT (DFT/GGA) and PerdewBurkeErnzerhof (PBE) exchange-correlation functional (Perdew et al., Phys. Rev. Lett. 77, 3865 (1996)). A 4×4×1 Γ-centered pack for k-vectors was used for k-point sampling. The simulations were run at 1000 K for several thousand time steps and no breaking of the bonds was seen indicating a high degree of stability.

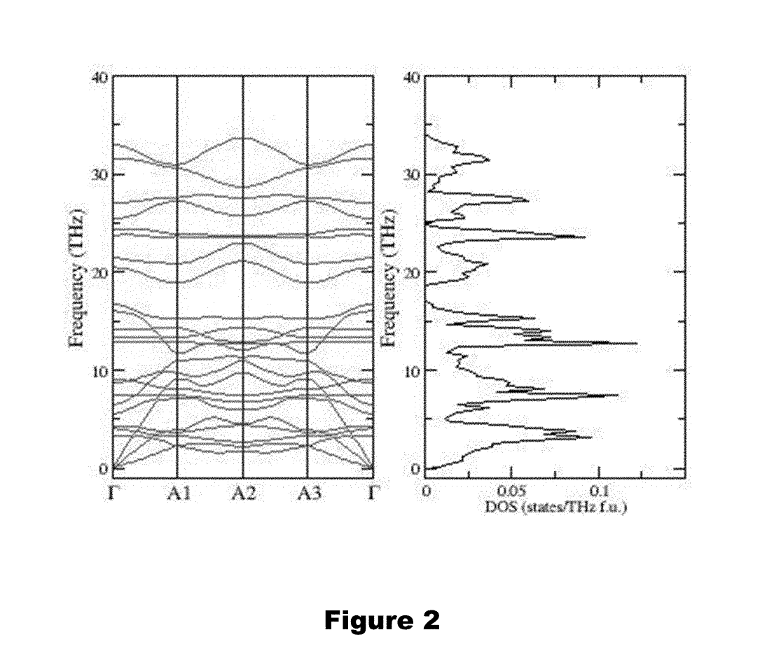

FIG. 2 shows the DFT results for band structure and density of states (DOS) with the HSE06 hybrid potential for the Si₂BN unit cell in FIG. 1. Examination of FIG. 2 reveals a conducting character which can be justified through an investigation of the correlation between the electronic structure and the structural model. Recall that the graphene possesses D₆ₕ symmetry which is lowered to D₃ₕ in the BN monolayer, while also loosing the inversion symmetry. The Fermi level (E_{F}) in graphene lies on a two-fold degenerate state at the K point of the Brillouin zone (BZ), which makes the monolayer a semimetal with zero gap. In the BN monolayer the reduction of symmetry lifts the degeneracy at the K point and opens a semiconducting gap⁴.

The Brillouin zone (BZ) of the single layer Si₂BN differs from that of graphene and BN layer because the hexagonal symmetry no longer exists and one of the directions is inequivalent to the other two. This lifts the degeneracies of the n bands at the symmetry points Γ, F and G. Furthermore, the lack of a two-fold rotation axis in the plane (C₂ᵥ symmetry) also eliminates any band crossings at other symmetry points between Γ, F and G. All these result in the separation of bands seen in the band structure. It should he noted, however, that despite the drastic reduction in symmetry the Si₂BN monolayer still retains the inversion symmetry which causes it to be metallic. Additionally, the strain caused by having to accommodate the 4 different nearest neighbor bonds also contributes to the states at E_{F}. From the DOS plot we find that the contribution to the states at E_{F} comes from the p-states of Si and N. Bond length analysis shows Si to bond to N more strongly than to B. The nonzero electronic density at E_{F} suggests potential for high-temperature superconductivity. In particular, the deviation from perfect sp² bond angles in plane could increase the electron-phonon coupling above the value in graphite.

The electronic structure of Si₂BN can be further altered through functionalization as has been demonstrated in the case of graphene where functionalization with hydrogen, oxygen, hydroxyl groups, and carboxylic groups has been shown to tune the optical and electronic properties (Moser et al., Appl. Phys. Lett. 91, 163513 (2007)). Furthermore, chemisorption of molecules has been shown to change the band structure of graphene dramatically from a near-zero gap semimetal to a wide gap semiconductor, turning graphene into a highly effective insulator (Elias et al., Science 323, 610 (2009)). The nanoribbons of Si₂BN could offer similar gap tunability through functionalization and chemisorption.

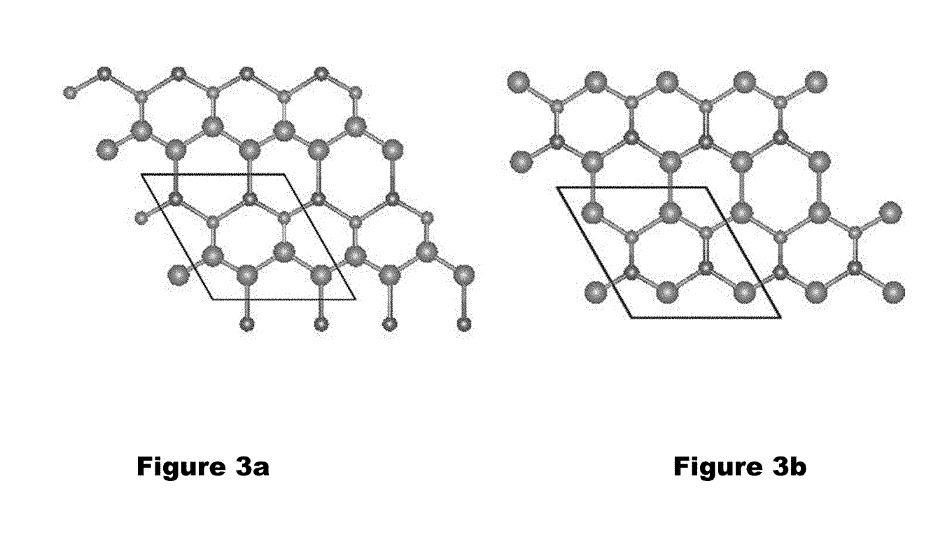

The difference charge densities of the atoms in the Si₂BN unit cell are shown in FIG. 3. Charge density differences are the difference between the initial, atomic charge density distribution as used to initiate a calculation and the final electronic charge density distribution resulting from a self-consistent calculation of the electronic ground state. As seen in FIG. 3, the bond charge distributions indicate a strong B—N bonding and a weaker Si—Si bonding with the Si—N and the Si—B bondings of intermediate strengths. The Si—N bond is seen to be slightly stronger than the Si—B bond. Based on our analysis we expect the Si sites to be more reactive for chemisorption.

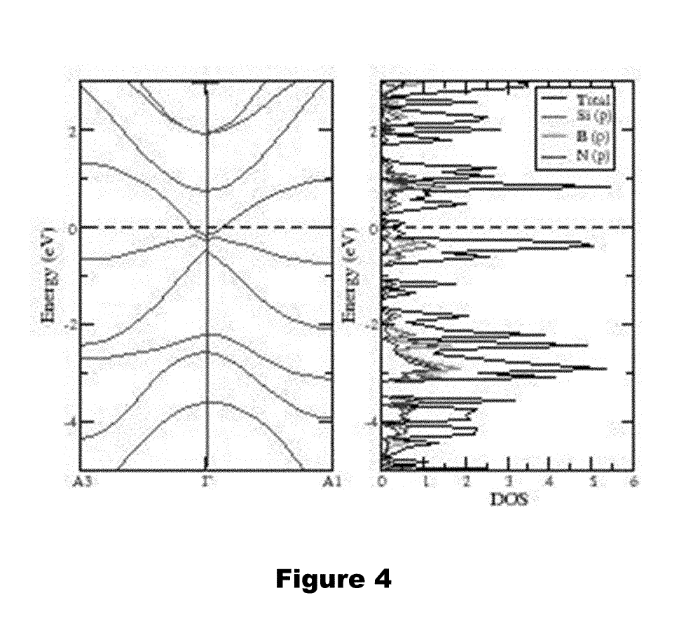

Further, similar to carbon and BN, the Si₂BN compound found in hexagonal graphitic structure may provide nanotube structures. The presence of three chemical species combined with the large covalent radii differences offer intriguing possibilities for nanotube formation that are distinct from carbon and BN nanotubes. For example, each of the zig-zag and arm-chair nanotubes could be formed with two different arrangements of the constituent elements as shown in FIG. 4. Furthermore, the anisotropic geometry of the hexagonal Si₂BN sheet offers a variety of ways of rolling the sheet into chiral nanotubes with a wide range of structural, electronic and chemical properties. For example, since the bond angles deviate from the ideal 120° on the nanotube wall, this could result in an increase of the π*-σ* orbital hybridization and alter the reactivity of the nanotube walls with bonding strengths varying with bonding sites. Based on the charge distribution analysis, the Si sites are expected to be more “sticky” (reactive) compared to other sites. This would indicate a chemistry distinct from those of C and BN based nanotubes.

The stability of the zig-zag and arm-chair nanotubes were tested using high temperature standard DFT/GGA simulations using large supercells. The electronic structure analysis using DFT reveals both zig-zag and armchair nanotubes to be metallic suggesting them to be one dimensional metals. There may be some technological advantages in that samples containing many different sizes and structures of nanotubes could be grown with predictable bulk properties.

In conclusion, herein is presented a new class of single atom thick graphene-like material formed from Si₂BN with unusual characteristics using ab initio simulations. Due to the 2D nature, the Si₂BN sheet can be flexible and strong and could exhibit other properties common to 2D materials such as high electron mobilities, tunable band structures, and high thermal conductivities. The inherent metallicity with sufficient DOS at E_{F} allows for substantial increase in conductivity by doping or by structural rearrangement (for example, induced by pressure). Other possibilities include high-temperature superconductivity with a transition temperature significantly exceeding that of intercalated graphite. The anisotropic conductivity may lead the chiral nanotubes to become helical conductors. This could be used to induce magnetic ordering of the magnetic moments of the metal atoms when placed inside the nanotube. The multilayer assemblies of Si₂BN could have a broad base of potential applications including batteries, supercapacitors, and p-n junctions. Experimentally, Si₂BN may be synthesized by incorporating Si into BN sheets which are typically synthesized in chemical vapor deposition (CVD) systems using solid and gaseous precursors (Song et al., Nano Lett. 10, 3209 (2010); Ismach et al., ACS Nano 6, 6378 (2012)).

### EXAMPLES

### Si₂BN Structural Analysis

The structure of Si₂BN was determined through the use of ab initio density functional theory (DFT) simulations, the hybrid exchange-correlation functional, Heyd-Scuseria-Ernzerhof (HSE06) (Heyd et al., J. Chem. Phys 124, 219906 (2006)) was used, which features exact exchange and, therefore, provides results for the electronic structure in better agreement with experiment. Calculations were performed using the Vienna Ab Initio Simulation Package (VASP) electronic structure computer code (Kresse et al., Phys. Rev. B 54, 11169 (1996)). FIG. 1 shows a graphical representation of the achieved structure.

The stability was then tested using ab initio molecular dynamics (MD) simulations at high temperatures by applying the standard DFT theory. Simulations were carried out using the Born-Oppenheimer molecular dynamics making use of the NPT ensembles of the VASP code, employing a computational cell containing 160 atoms subject to standard periodic boundary conditions and an integration time step of 1.5 fs. The energies and forces are obtained from electronic structure calculations within the generalized gradient approximation (GGA) of the DFT (DFT/GGA) and PerdewBurkeErnzerhof (PBE) exchange-correlation functional (Perdew et al., Phys. Rev. Lett. 77, 3865 (1996)). A 4×4×1 Γ-centered pack for k-vectors was used for k-point sampling. The simulations were run at 1000 K for several thousand time steps and no breaking of the bonds was seen indicating a high degree of stability.

The stability of the zig-zag and arm-chair Si2BN nanotubes were tested using high temperature standard DFT/GGA simulations using large supercells. The electronic structure analysis using OFT reveals both zig-zag and armchair nanotubes to be metallic suggesting them to be one dimensional metals.

### Si₂BN Production

Production of Si₂BN can be achieved through reacting ammonium borane with silane on a copper surface substrate (See, generally, Beniwal et al., ACS Nano Article ASAP, DOI: 10.1021/acsnano.6b08136). In short, a copper substrate provides a surface for epitaxial growth of Si₂BN from the precursor materials.

The foregoing descriptions of various embodiments provide illustration of the inventive concepts. The descriptions are not intended to be exhaustive or to limit the disclosed invention to the precise form disclosed. Modifications or variations are also possible in light of the above teachings. The embodiments described above were chosen to provide the best application to thereby enable one of ordinary skill in the art to utilize the inventions in various embodiments and with various modifications as are suited to the particular use contemplated. All such modifications and variations are within the scope of the invention. All publications, patents and patent applications referenced herein are to be each individually considered to be incorporated by reference in their entirety.

We claim:

1: A graphiticized hexagonal monolayer of Si₂BN, wherein each Si atom has a Si, B, and N nearest neighbor, each B has two Si's and one N as nearest neighbors and each N has two Si's and one B as nearest neighbors.

2: The monolayer of claim 1, wherein the Si2BN comprises a structure of:

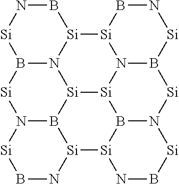

3: The monolayer of claim 1, wherein each atom is connected by sp² bonding.

4: The monolayer of claim 1, wherein the monolayer rests within a single plane.

5: The monolayer of claim 1, wherein the monolayer does not buckle out from a single plane.

6: A nanotube comprising the monolayer of claim 1, wherein the monolayer is rolled to achieve a zig-zag orientation.

7: A nanotube comprising the monolayer of claim 1, wherein the monolayer is rolled to achieve an arm-chair orientation.

8: A method for manufacturing the monolayer of claim 1, comprising reacting ammonium borate and silane on a copper substrate under high vacuum.

9: A graphiticized hexagonal monolayer of X₂BN that comprises the structure: 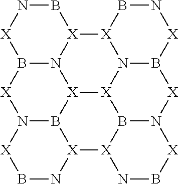
wherein X is carbon or silicon.
